(19) United States
(12) Patent Application Publication
(10) Pub. No.: US 2013/0243207 A1
(43) Pub. Date: Sep. 19, 2013

(54) ANALYSIS SYSTEM AND METHOD FOR AUDIO DATA

(71) Applicants: Evan Liu, Beijing (CN); Qiang Li, Taby (SE); Olof Lundstrom, Jarfalla (SE); Tandy Mai, Chengdu (CN)

(72) Inventors: Evan Liu, Beijing (CN); Qiang Li, Taby (SE); Olof Lundstrom, Jarfalla (SE); Tandy Mai, Chengdu (CN)

(73) Assignee: Telefonaktiebolaget L M Ericsson (PUBL), Stockholm (SE)

(21) Appl. No.: 13/989,385

(22) PCT Filed: Nov. 25, 2010
(86) PCT No.: PCT/CN2010/001889

§ 371 Date: May 23, 2013

(51) Int. Cl. H04R 29/00

(52) U.S. Cl. CPC H04R 29/00
USPC 381/56

(57) ABSTRACT

An analysis system and method for audio data related to a user is provided, so that the user can be classified as one of multiple classes with an assumed probability based on the analysis result. The analysis system comprises an audio transformer (110) adapted to transform the audio data related to the user into spectra data; a pattern recognizer (120) adapted to decompose the spectra data to predetermined eigenvectors to get the decomposition pattern of the spectra data; a scorer (130) adapted to calculate the assumed scores of the multiple classes related to the user based on the decomposition pattern of the spectra data and the attributes of the user using a trained model.

### TECHNICAL FIELD

The invention related to the technical field of audio analysis, in particular to an analysis system and method for analyzing an audio data related to an user such as a Caller Ring-back Tone of the user so that the user can be classified based on the analysis result. The invention further relates to a computer program and a computer program product for implementing the audio analysis system and method.

### BACKGROUND

Telemarketing is a direct marketing method that a salesperson tries to dial and solicit prospective customers to buy products or services. Many B2B or B2C companies heavily utilize such method.

Traditional telemarketing system can provide the salesperson with background information of customers retrieved from support system such as CRM (Customer Relationship Management) system or EDW (Enterprise Data Warehouse) system, so that when the salesperson making conversation with the customers, the salesperson can be aided with the background information of the customers.

However, the traditional telemarketing system usually has the following major disadvantages:

(1) Lack of personalization: the support system may only provide the simplest information of the customer such as the name, phone number, email, etc of the customer. So salesperson cannot figure out the personalized tactics for different customers; and

(2) Lack of online performance improvement cycle: since the support system only provided the simplest information of the customer, the salesperson can not improve his performance during cycles of calls.

It can be found that the main disadvantage of the traditional telemarketing system is mainly due to the simple function of the support system. In order to improve the telemarketing efficiency and performance, the support system should provide enhanced information of the customer.

CRBT (Caller Ring-back Tone) is a personalized version of RBT (Ring-Back Tone). RBT is the song or sound that is heard on the telephone line by the calling party after dialing and prior to the call being answered at the receiving end. Nowadays, more and more people personalized their RBT to provide CRBT.

Thus, one problem associated with the traditional telemarketing system is that the support system can only provide the simple information of the customer.

### SUMMARY

It is an object of the invention to increase the personalized data in a telemarketing system.

According to an aspect of the invention, this object is enabled with the help of an analysis system for analysis an audio data related to a user so that the user can be classified as one of multiple classes with an assumed probability based on the analysis result. The analysis system comprises an audio transformer adapted to transform the audio data related to the user into a spectra data; a pattern recognizer adapted to decompose said spectra data to predetermined eigenvectors to get a decomposition pattern of the spectra data; and a scorer adapted to calculate assumed scores of multiple classes related to the user based on the decomposition pattern of the spectra data and attributes of the user using a trained model.

Optionally, in the analysis system of the invention, the scorer attributes the user to a class with highest assumed score among all of the multiple classes. The assumed class associated with the user can be used in some application such as the telemarketing system to aid the salesperson with more personalized information of the user, so that the telemarketing efficiency and performance can be improved.

Optionally, the analysis system of the invention comprises a trainer adapted to train the trained model based on at lease one history item each comprising a decomposition pattern of a spectra data corresponding to a history audio data of a history user, attributes of the history user, and an actual score of one of the multiple classes for the history user, and the trainer retrains the trained model based on the history items and a new item comprising the decomposition pattern of the spectra data, the attributes of the user, and an actual score of an actual class of the multiple classes. By continuous training the trained model using the history items and the actual result, the accuracy of assumed result calculated by the scorer using the trained model is improving.

Optionally, in the analysis system of the invention, the scorer is based on Naïve Bayes Classifier, and the assumed scores of the multiple classes is a posterior probability of the multiple classes over the decomposition pattern of the spectra data and the attributes of the user.

Optionally, the analysis system of the invention comprises an audio database to store audio data related to various users; a spectra database to store the spectra transformed from the audio data stored in the audio database; and an eigenvector generator adapted to process the spectra in the spectra database using Principle Component Analysis method to generate the predetermined eigenvectors.

Optionally, in the analysis system of the invention, the audio data to be analyzed comprises a Caller Ring-back Tone (CRBT) of the user, since the CRBT is commonly used personalized tone of the user in telecommunication system, analyzing the CRBT of the user is especially useful when the analysis system of the present invention is used in the telemarketing system.

According to another aspect of the invention, this object is enabled by an analysis method for analyzing an audio data related to a user so that the user can be classified as one of multiple classes with an assumed probability based on the analysis result. The analysis method comprises the following steps: transforming the audio data related to the user into a spectra data; decomposing said spectra data to predetermined eigenvectors to get a decomposition pattern of the spectra data; and calculating assumed scores of multiple classes related to the user based on the decomposition pattern of the spectra data and attributes of the user using a trained model.

Optionally, the analysis method of the invention comprises the step of attributing the user to a class with highest assumed score among all of the multiple classes.

Optionally, the analysis method of the invention comprises the steps of training the trained model based on history items each comprising a decomposition pattern of a spectra data corresponding to a history audio data of a history user, attributes of the history user, and an actual score of one of the multiple classes for the history user, and retraining the trained model based on the history items and a new item comprising the decomposition pattern of the spectra data, the attributes of the user, and an actual score of an actual class of the multiple classes.

Optionally, in the analysis method of the invention, the step of calculating assumed scores of multiple classes is based on Naïve Bayes Classifier, and the assumed scores of the multiple classes being a posterior probability of the multiple classes over the decomposition pattern of the spectra data and the attributes of the user.

Optionally, the analysis method of the invention comprises the steps of transforming audio data related to various users stored in a audio database into corresponding spectra; and processing the corresponding spectra using Principle Component Analysis method to generate the predetermined eigenvectors.

Optionally, in the analysis method of the invention, the audio related to the user comprising a Caller Ring-back Tone of the user.

According to another aspect of the invention, there is provided a telemarketing system comprising an analysis system of the invention to analysis the audio related to clients of the telemarketing system.

According to another aspect of the invention, there is provided a computer program, comprising computer readable code which when running on an application server, causes the application server to perform the analysis method according to any one of the embodiments described above, and there is further provided a computer-readable medium with the computer program stored thereon.

### BRIEF DESCRIPTION OF THE DRAWINGS

The objects, advantages and effects as well as features of the invention will be more readily understood from the following detailed description of embodiments of the invention when read together with the accompanying drawings, in which:

FIG. 1 illustrates an analysis system for analyzing an audio data related to a user according to an embodiment of the invention;

FIG. 2 shows a flow chart of an analysis method for analyzing an audio data related to a user according to an embodiment of the invention;

FIG. 3 shows a part of flow chart of the analysis method of FIG. 2 for generating a predetermined eigenvector according to an embodiment of the invention;

FIG. 4 shows a telemarketing system using the analysis system according to an embodiment of the invention;

FIG. 5 shows a block diagram illustrating a server for implementing the embodiment of the invention; and

FIG. 6 shows a schematic of a memory unit holding or carrying program code for use by a server.

### DETAILED DESCRIPTION

While the invention covers various modifications and alternative constructions, embodiments of the invention are shown in the drawings and will hereinafter be described in detail. However it should be understood that the specific description and drawings are not intended to limit the invention to the specific forms disclosed. On the contrary, it is intended that the scope of the claimed invention includes all modifications and alternative constructions thereof falling within the scope of the invention as expressed in the appended claims.

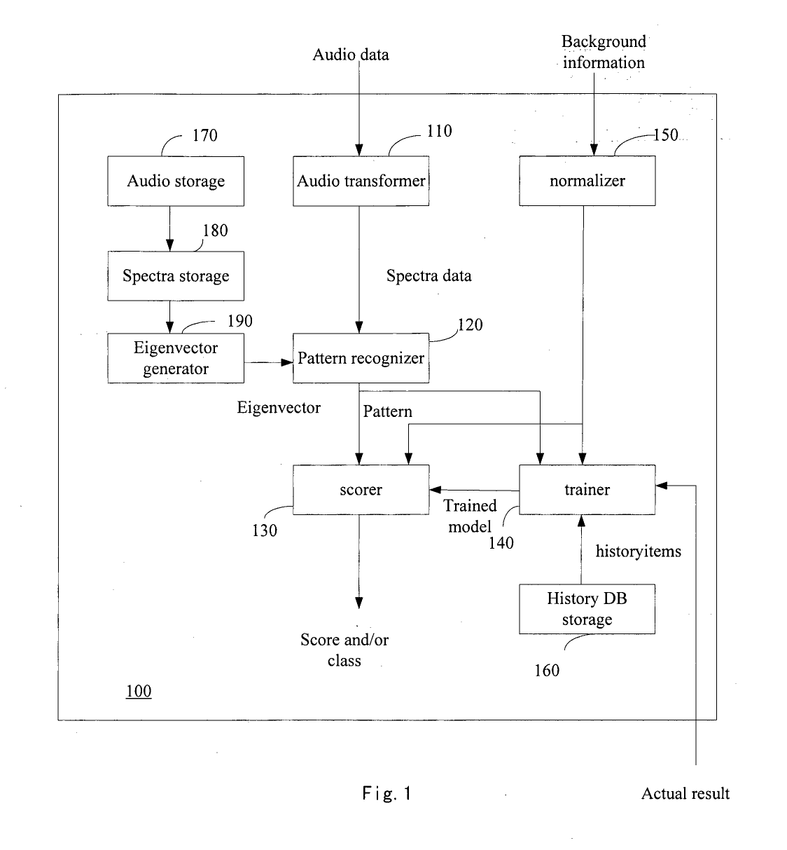

FIG. 1 illustrates an explanation analysis system 100 for analyzing an audio data related to a user according to an embodiment of the invention. As shown in FIG. 1, the analysis system 100 comprises an audio transformer 110 adapted to transform the audio data related to the user into a spectra data. The audio data related to the user can be any audio data specific to the user, such as the Caller Ring-back Tone personalized by the user in the telecommunication system, something spoken by the user, or any other audio data which can be personalized by the user to reflect the interesting or character of the user. The audio data received by the audio transformer 110 is usually in digital form, and there exists many ways which can be used by the audio transformer 110 to transform the audio data into the spectrum field. According to an embodiment, FFT (Fast Fourier Transform) is employed in the audio transformer 110 to transform the audio data into a spectra data. It should be noted that the FFT is just an example, any technique which can transform a value into spectra field can be used in the invention. For example, any one of STE (Short Time Energy), MFCC (Mel Frequency Cepstrum Coefficient), LPC (Line Prediction coefficient) and so on can also be used to transform the audio data.

The analysis system 100 further comprises a pattern recognizer 120 adapted to get a decomposition pattern of the spectra data from the audio transformer. According to an embodiment of the invention, the pattern recognizer 120 gets the decomposition pattern of the spectra data by decomposing the spectra data to predetermined eigenvectors. The predetermined eigenvectors can be derived from a lot of existing audio data which will be described in detail in the following description. Assuming the predetermined eigenvectors can be represented by:

eigenvectorᵢ, i=1 . . . k, (1)

the spectra data can be decomposed as following:

$$spectra ( spectra\_data ) = {\sum }_{i = 0}^{k} {α}_{i} {eigenvector}_{i} , \qquad ( 2 )$$

wherein αᵢ being the decomposition factors and the decomposition pattern of the spectra data can be:

pattern(spectra_data)=(α₀, α₁, . . . , αₖ)^{T}. (3)

That is, by decomposing the spectra data to a composition of eigenvectors, the resulted decomposition factors can be recorded as the decomposition pattern of the spectra data.

The analysis system 100 further comprises a scorer 130 adapted to calculate assumed scores of multiple classes related to the user based on the decomposition pattern obtained by the pattern recognizer 120 and background information of the user using a trained model.

The classes related to the user may be varied depending on the application where the analysis system 100 is applied. For example, in the case the analysis system is used to analyze the willingness of the user to buy a product, the classes may comprise a class with the attribute accept to buy C_{accept} and a class with the attribute reject to buy C_{reject}. In the case the analysis system is used to analysis the willing of the user to upgrade some service owned, the classes may comprise a class with the attribute accept to upgrade C_{accept} and a class with the attribute reject to upgrade C_{reject}. It should be noted that, the number of classes is not limited to two, and more than two classes can be used, for example, in the case the analysis system is used to analyze the willingness of the user to buy a product as described above, the classes may comprises more than two classes, such as a class with the attribute accept to buy C_{accept}, a class with the attribute accept to try C_{try}, a class with the attribute reject by delaying C_{delay}, and a class with the attribute reject to buy C_{reject}. Those classes reflect the user's preference which may have some implicitly association with the personalization information of the user, such as the audio data personalized by the user. The assumed scores of multiple classes represent the probability of user being classified as one of those classes calculated by the scorer 130.

According to an embodiment, the scorer 130 can calculate assumed scores of multiple classes related to the user by means of the probabilistic approach of machine learning, that is, the trained model can be a probability model used in the probabilistic approach of machine learning. The following description will take the Naive Bayes Classifier as the probabilistic approach used by the scorer 130 as an example, however, it should be noted that the present application is not limited to the Naive Bayes Classifier, other probabilistic approach in the machine learning can also be applicable in the present application, for instance SVM (Support Vector Machine).

In the Naive Bayes Classifier, there is defined a vector of features, (F₀, F₁, . . . , Fₖ)^{T}. The features of the vector would be decomposition pattern of the spectra data and the background information of the user. The assumed score of the vector for class C is defined as the posterior probability of class C over the vector of features:

score_{C}=p(C|F₀, F₁, . . . , Fₖ). (4)

Based on assumption of independencies among F₀, F₁, . . . , Fₖ, the assumed score can be represented as below:

$${score}_{C} = \frac{1}{Z} p ( C ) {\prod }_{i = 0}^{k} p ( {F}_{i} \vert C ) , \qquad ( 5 )$$

wherein Z is a scaling factor dependent only on F₀, F₁, . . . , Fₖ, which is a constant value for all classes and can be neglected when calculating the score for each class C; p(C) is the probability of class C; and p(Fᵢ|C) represents the probability of the existence of feature Fᵢ if class C appears. It should be noted that both p(C) and p(Fᵢ|C) are prior probabilities known by the trained model.

In additional to calculating the assumed score of each class by using the probabilistic approach of machine learning such as the equation (5) described above, optionally, the scorer 130 can further attribute the user to a suggested class with highest assumed score among all of the multiple classes. In the embodiment employing naïve Bayes Classifier, the suggested class C, class_{suggest} can be computed as the class c with the highest score score_{C}:

$${class}_{suggest} = {argmax}_{c} ( {score}_{C = c} ) \qquad ( 6 )$$

The background information of the user can be retrieved from some traditional support system such as CRM (Customer Relationship Management) system or EDW (Enterprise Data Warehouse) system, and the background information may comprise the age, sex, city, etc. information of the user.

Optionally, the background information of the user may be descriptive such as “male” or “female” regarding the sex of the user, which can not be directly used in the scorer 130 where some numeric value is required, the analysis system 100 further comprises an attribute normalizer 150 adapted to convert the background information of the user into numeric values. For example, regarding the sex of the users, “male” can be converted into value 1 and “female” can be converted into value 0. According to an embodiment of the present invention, the attribute normalizer 150 can convert the background information of the user into numeric values ranging from 0 to 1, so that the scorer 130 can easily use a vector of the background information during the operation.

The trained model used by the scorer 130 is trained by a trainer 140 in the analysis system 100 based on the history items. Each history item corresponds to a history audio data related to a history user analyzed previously by the analysis system 100, which may comprise a decomposition pattern of a spectra data corresponding to the history audio data, attributes of the history user, and an actual score of one of the multiple classes for the history user. After the assumed score provided by the analysis system 100 been used in various applications, the user of those applications can provide the actual score of the class to the analysis system 100. The trainer 140 can use any method known in the probabilistic approach of machine learning field to train the trained model based on the history items. According to an embodiment of the invention, it is assumed that the trained model can be a predetermined model such as any one of normal, lognormal, gamma and Poisson density functions model with some parameters to be determined, and the training method involves using the known history items to calculate those parameters by any know approach method, so that the trained model can reflect those history item most accurate.

Optionally, the analysis system 100 further comprises a history DB storage 160 to store the history items. The trainer 140 may train the trained model in a continuously way, that is, when a new audio data of a user is analyzed by the analysis system 100, the trainer 140 may retrain the trained model using a new item comprising the decomposition pattern of the spectra data corresponding to the new audio data, the background information of the user, and the actual score of the class as well as the history items. By retraining the trained model using the practice result continuously, the scorer 130 based on the trained model can provide a more and more accurate result.

As described above, the predetermined eigenvectors can be derived from a lot of existed audio data. In order to derive the predetermined eigenvectors, optionally, the analysis system 100 further comprises an audio storage 170 storing a large number of audio data related to various users; a spectra storage 180 storing the spectra data transformed from the audio data stored in the audio storage; and a eigenvector generator 190 adapted to process the spectra in a spectra storage 180 to generate the predetermined eigenvectors. The audio data stored in the audio storage 170 may be in digital form, and similar to the operation of the audio transformer, the audio data can be transformed into the spectrum field and stored as spectra data in the spectra storage 180 using any known method such as the FFT, STE, MFCC and LPC. According to an embodiment of the application, the eigenvector generator 190 derives the predetermined eigenvectors from the spectra data stored on the spectra storage 180 using the Principle Component Analysis (PCA) method, however, any method which can derive the predetermined eigenvectors from underlying spectra data can also be applicable within the protection scope of the present application.

By using the analysis system 100, the audio data specific to or personalized by the user can be used to characterized the preference of the user in additional to the common background information of the user. Those audio data may reflect some character of the user and may have some implicitly association with the preference of the user, the analysis system 100 of the invention provide a new way to leverage those audio data of the user, and can be used in various application for assist figuring out the preference of the user.

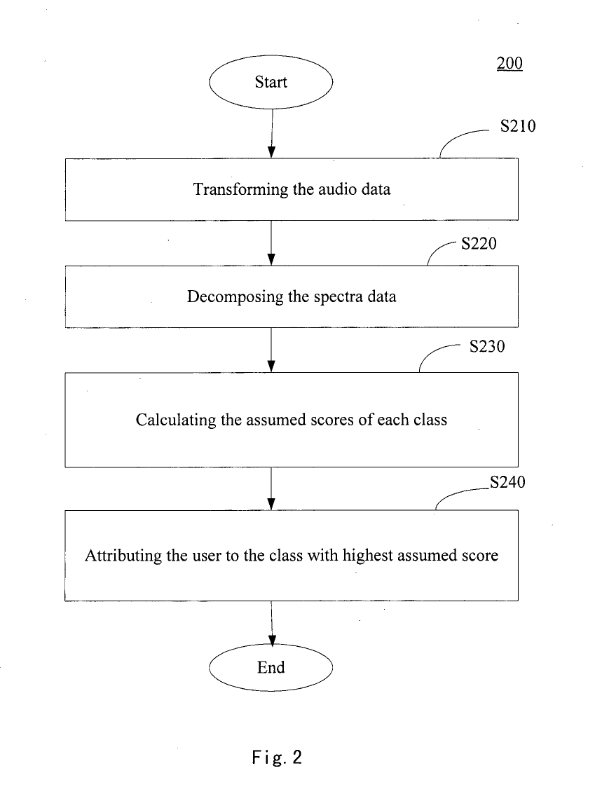

FIG. 2 shows a flow chart of an analysis method 200 for analyzing an audio data related to a user according to an embodiment of the invention. The analysis method 200 can be executed by the analysis system 100 of the invention. The analysis method 200 is begun with step S210, wherein the audio data related to the user is transformed into spectra data. The audio data related to the user can be any audio data specific to the user, such as the Caller Ring-back Tone personalized by the user in the telecommunication system, something spoken by the user, or any other audio data which can be personalized by the user to reflect the interesting or character of the user. In step S210, there exists many ways which can be used to transform the audio data into the spectrum field. According to an embodiment of the invention, the FFT (Fast Fourier Transform) can be adopt to transform the audio data into a spectra data. It should be noted that other techniques, such as any one of STE, MFCC and LPC can also be used to transform the audio data. Optionally, the process of step S210 can be executed by the audio transformer 110 of the analysis system 100.

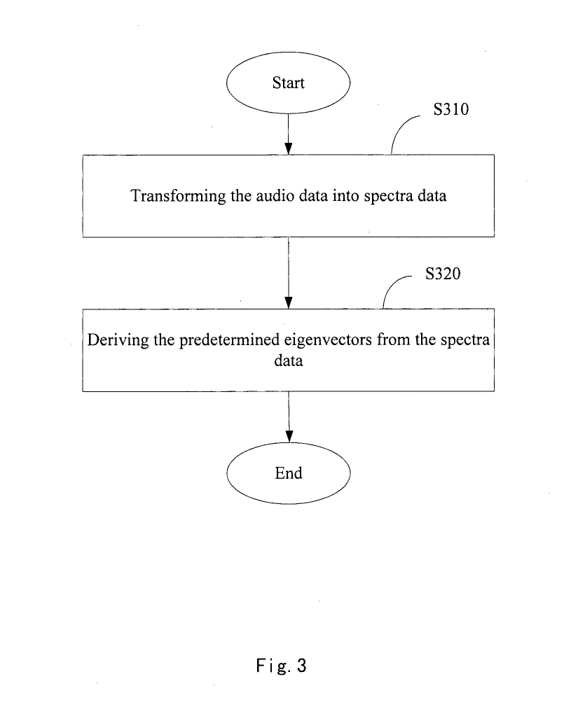

Then the method 200 proceeds to step S220, wherein the spectra data obtained in step S210 is decomposed to predetermined eigenvectors to get a decomposition pattern of the spectra data. The predetermined eigenvectors are derived from a lot of existed audio data, and the steps for deriving the predetermined eigenvectors will be described in the following in connection with FIG. 3. According to an embodiment of the invention, the decomposition pattern of the spectra data can be obtained according to the description in connection with Equation (1)-(3) as described above. Optionally, the process of step S220 can be executed by the pattern recognizer 120 of the analysis system 100.

Based on the decomposition pattern of the spectra data obtained in step S220 and the background information of the user which may be retrieved from some traditional support system such as CRM (Customer Relationship Management) system or EDW (Enterprise Data Warehouse) system, in Step S230, the assumed scores of multiple classes related to the user are calculated using a trained model. As described previously, according to an embodiment of the present invention, the probabilistic approach of machine learning can be used in step S230, and the trained model can be probability model used in the probabilistic approach of machine learning. The assumed scores of multiple classes can also be calculated based on the Naive Bayes Classifier described above. Optionally, the process of step S230 can be executed by the scorer 130 of the analysis system 100.

In additional, after the assumed scores of multiple classes have been calculated in step S230, the analysis method may further comprise a step S240 to attribute the user to a class with highest assumed score among all of the multiple classes. The step S240 can also be executed by the scorer 130 of the analysis system 100.

Optionally, before the background information of the user has been used in step S230 to calculate the assumed scores of multiple classes, the method further comprise a step to converting the background information of the user into numeric values especially ranging from 0 to 1 which may be executed by the normalizer 150 of the analysis system 100, so that such background information can be easily used in step S230.

Optionally, the trained model should be trained before using in step S230, the trained model can be trained based on the history items. Each history item corresponds to an audio data analyzed previously by the analysis method, which may comprise a decomposition pattern of a spectra data corresponding to a history audio data of a history user, attributes of the history user, and an actual score of one of the multiple classes for the history user. The analysis method of the present invention further comprise a step for training the trained model using any method known in the probabilistic approach of machine learning field based on the history items.

In additional, the trained model should be trained in a continuously way, that is, when a new audio data of a user is analyzed by the analysis method, the analysis method further comprises a method step to retrain the trained model using a new item comprising the decomposition pattern of the spectra data corresponding to the new audio data, the background information of the user, and the actual score of the class and the history items. By retraining the trained model using the practice result continuously, the trained model can provide a more accurate result. Optionally, the method steps for training and retraining the trained model can be performed by the trainer 140 of the analysis system 100.

As described above, the predetermined eigenvectors can be derived from a lot of existed audio data. FIG. 3 shows the flow chart of the step S220 of the analysis method of FIG. 2 for generating a predetermined eigenvector according to an embodiment of the invention. In step S310, a lot of audio data which may be stored in the audio storage 170 of analysis system 100 is transformed into spectra data using any known method for transforming a digital signal into spectrum field such as FFT. The spectra data may be stored in the spectra storage 180 of analysis system 100. Then in step S320, the spectra data obtained in step S310 is processed to generate the predetermined eigenvectors. According to an embodiment of the present application, the predetermined eigenvectors are derived from the spectra data using the Principle Component Analysis (PCA) method, however, any method which can derive the predetermined eigenvectors from underlying spectra data can also be applicable within the protection scope of the present application.

According to the analysis method of the present invention, the audio data specific to or personalized by the user can be used to characterized the preference of the user in additional to the common background information of the user. Those audio data may reflect some character of the user and may have some implicitly association with the preference of the user, the analysis method of the present invention provide a new way to leverage those audio data of the user, and can be used in various application for assisting in figuring out the preference of the user.

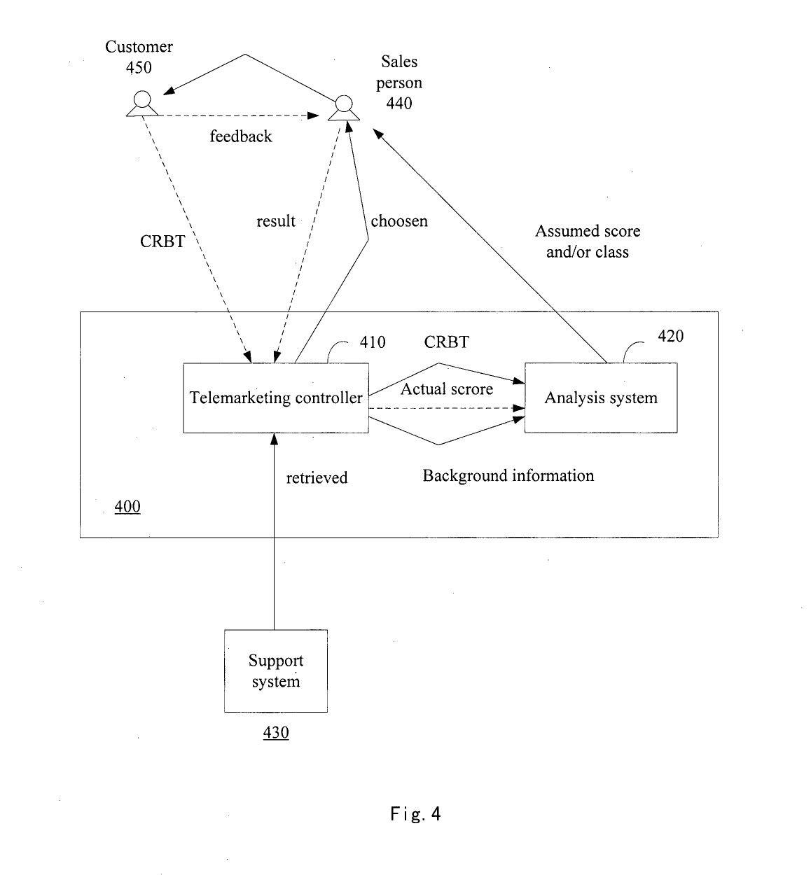

FIG. 4 shows a telemarketing system 400 using an analysis system according to an embodiment of the invention. The telemarketing system 400 comprises a telemarketing controller 410 and an analysis system 420 according to an embodiment of the invention. As shown in FIG. 4, the salesperson 440 of the telemarketing system 400 can choose a customer 450 from a support system 430 such as CRM (Customer Relationship Management) system or EDW (Enterprise Data Warehouse) system via the telemarketing controller 410, and then dial the chosen customer. Then the CRBT of the customer will be recorded to the telemarketing controller 410. The telemarketing controller 410 sends the CRBT of the customer as well as other background information from the support system 430 to the analysis system 420. The analysis system 420 will instantly start to analyze the CRBT and the background information to output scoring results. The salesperson 440 can immediately get the scoring results for early feedback to make decisions and take proper measures when making telemarketing with the customer 450. After the telemarketing, the salesperson 440 can provide the sales result, that is the actual scores to the telemarketing controller 410, and the telemarketing controller 410 will send such actual scores to the analysis system 420, so that this actual scores and the corresponding CRBT and background information of the user can be used to retrain the trained model used by the scorer of the analysis system 420 and may be stored as an history item into the history DB storage of the analysis system 420

Using the analysis system of the present application, the telemarketing system will have the following benefits, that is, the analysis system can help salesperson to make personalized decisions and get better preparation for the call based on the early analysis results and the trained model can be retrained for every telemarketing attempt and continuously improved which in turn helps the salesperson to gain performance boost and lift his efficiency.

It should be noted that in the analysis system 100, the components therein are logically divided dependent on the functions to be achieved, but this invention is not limited to this, the respective components in the analysis system 100 can be re-divided or combined dependent on the requirement, for instance, some components may be combined into a single component, or some components can be further divided into more sub-components.

Embodiments of the present invention may be implemented in hardware, or as software modules running on one or more processors, or in a combination thereof. That is, those skilled in the art will appreciate that special hardware circuits such as Application Specific Integrated Circuits (ASICs) or digital signal processor (DSP) may be used in practice to implement some or all of the functionality of all component of the analysis system 100 according to an embodiment of the present invention. Some or all of the functionality of the components of the analysis system 100 may alternatively be implemented by a microprocessor of an application server in combination with e.g. a computer program, which computer program when run on the microprocessor causes the application server to perform, for example, the steps of the analysis method as described above. The invention may also be embodied as one or more device or apparatus programs (e.g. computer programs and computer program products) for carrying out part or all of any of the methods described herein. Such programs embodying the present invention may be stored on computer-readable media, or could, for example, be in the form of one or more signals. Such signals may be data signals downloadable from an Internet website, or provided on a carrier signal, or in any other form.

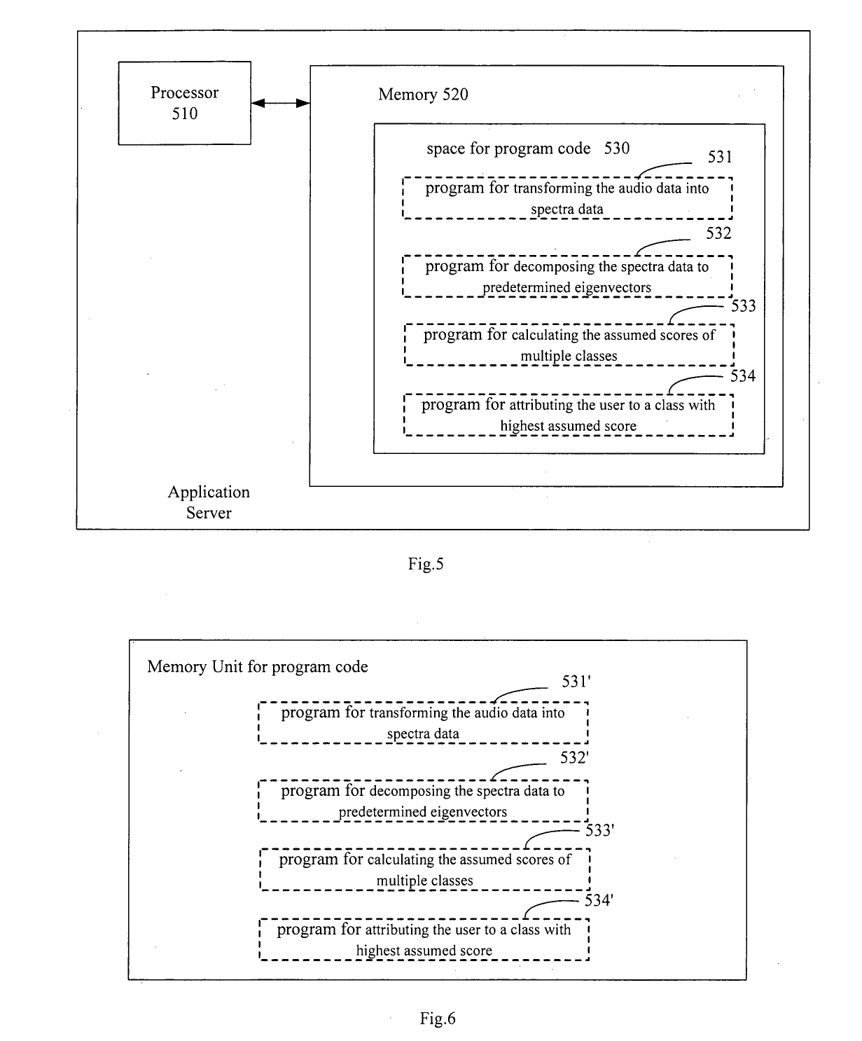

For example, FIG. 5 shows a server, e.g. an application server, which can implement the embodiment of the application, the server can comprise in the conventional way a processor 510 and a computer program product/computer readable medium in the form of a memory 520. The memory 520 may be an electronic memory such as a flash memory, an EEPROM (Electrically Erasable Programmable Read-only memory), an EPROM (Erasable Programmable Read-only memory), a hard disc or an ROM. The memory 520 can have spaces for program code 530 for performing any method steps described previously. For example, the space for program code 530 may comprise program 531 for transforming the audio data related to the user into spectra data as described previous in step S210, program 532 for decomposing the spectra data to predetermined eigenvectors to get a decomposition pattern of the spectra data as described previous in step S220, program 533 for calculating the assumed scores of multiple classes related to the user using a trained model as described previous in step S230 and program 534 for attributing the user to a class with highest assumed score among all of the multiple classes as described previous in step S240. The program code can have been written to and can be or have been read from one or more computer program products, i.e. program code carriers, such as a hard disc, a compact disc (CD), a memory card or a floppy disc. Such a computer program product is generally a memory unit that can be portable or stationary as illustrated in the FIG. 6. It can have memory segments, memory cells and memory spaces arranged substantially as in the memory 520 of the server of FIG. 5. The program code can e.g. be compressed in a suitable way. Generally, the memory unit thus comprises computer readable code, i.e. code that can be read by an electronic processor such as 510, which when run by a server causes the server to carry out steps for executing one or more of the procedures or procedural steps that the server performs according to the description above.

It should be noted that the aforesaid embodiments are illustrative of this invention instead of restricting this invention, substitute embodiments may be designed by those skilled in the art without departing from the scope of the claims enclosed. The word “include” does not exclude elements or steps which are present but not listed in the claims. The word “a” or “an” preceding the elements does not exclude the presence of a plurality of such elements. This invention can be achieved by means of hardware including several different elements or by means of a suitably programmed computer. In the unit claims that list several means, several ones among these means can be specifically embodied in the same hardware item. The use of such words as first, second, third does not represent any order, which can be simply explained as names.

1. An analysis system for analysis of audio data related to a user, comprising:
an audio transformer adapted to transform the audio data into a spectra data;
a pattern recognizer adapted to decompose the spectra data to predetermined eigenvectors to get a decomposition pattern of the spectra data; and
a scorer adapted to calculate assumed scores of multiple classes related to the user based on the decomposition pattern of the spectra data and attribute of the user using a trained model.

2. The audio analysis system according to claim 1, wherein the scorer is adapted to attribute the user to a class with highest assumed score among all of the multiple classes.

3. The audio analysis system according to claim 1, further comprising:
a trainer adapted to train the trained model based on at least one history item each comprising a decomposition pattern of a spectra data corresponding to a history audio data of a history user, attributes of the history user, and an actual score of one of the multiple classes for the history user.

4. The audio analysis system according to claim 3, wherein the trainer is adapted to retrain the trained model based on the history items and a new item comprising the decomposition pattern of the spectra data, the attributes of the user, and an actual score of an actual class of the multiple classes.

5. The audio analysis system according to claim 1, wherein the scorer is based on Naïve Bayes Classifier, and the assumed scores of the multiple classes are a posterior probability of the multiple classes over the decomposition pattern of the spectra data and the attributes of the user.

6. The audio analysis system according to claim 1, further comprising:
an audio database storing audio data related to various users;
a spectra database storing the spectra transformed from the audio data stored in the audio database; and
an eigenvector generator adapted to process the spectra in the spectra database using a Principle Component Analysis method to generate the predetermined eigenvectors.

7. The audio analysis system according to claim 1, wherein the decomposition pattern of the spectra data comprises the decomposition factors of the predetermined eigenvectors.

8. The audio analysis system according to claim 1, further comprising:
an attribute normalizer adapted to convert the attributes of the user into numeric values ranging from 0 to 1.

9. The audio analysis system according to claim 1, wherein the attributes of the user comprises one or more of an age, sex, and city related to the user.

10. The audio analysis system according to claim 1, wherein the audio related to the user comprises a Caller Ring-back Tone of the user.

11. A analysis method for analyzing an audio data of a user, comprising the steps of:
transforming the audio data related to the user into a spectra data;
decomposing said spectra data to predetermined eigenvectors to get a decomposition pattern of the spectra data; and
calculating assumed scores of multiple classes related to the user based on the decomposition pattern of the spectra data and attributes of the user using a trained model.

12. The audio analysis method according to claim 1, further comprising the step of:
attributing the user to a class with highest assumed score among all of the multiple classes.

13. The audio analysis method according to claim 11, further comprising the step of:
training the trained model based on history items each comprising a decomposition pattern of a spectra data corresponding to a history audio data of a history user, attributes of the history user, and an actual score of one of the multiple classes for the history user.

14. The audio analysis method according to claim 13, further comprising the step of:
retraining the trained model based on the history items and a new item comprising the decomposition pattern of the spectra data, the attributes of the user, and an actual score of an actual class of the multiple classes.

15. The audio analysis method according to claim 11, wherein the step of calculating assumed scores of multiple classes is based on Naïve Bayes Classifier, and the assumed scores of the multiple classes are a posterior probability of the multiple classes over the decomposition pattern of the spectra data and the attributes of the user.

16. The audio analysis method according to claim 11, further comprising the steps of:
transforming audio data related to various users stored in a audio database into corresponding spectra;
processing the corresponding spectra using a Principle Component Analysis method to generate the predetermined eigenvectors.

17. The audio analysis method according to claim 11, wherein the decomposition pattern of the spectra data comprises the decomposition factors of the predetermined eigenvectors.

18. The audio analysis method according to claim 11, further comprising the step of:
before the step of calculating assumed scores of multiple classes, converting the attributes of the user into numeric values ranging from 0 to 1.

19. The audio analysis method according to claim 11, wherein the attributes of the user comprises one or more of an age, sex, and city related to the user.

20. The audio analysis method according to claim 11, wherein the audio related to the user comprises a Caller Ring-back Tone of the user.

21. A telemarketing system, comprising an audio analysis system according to claim 1 to analyze the audio related to a customer of the telemarketing system.

22. A non-transitory computer program, comprising computer readable code which when running on an application server, causes the application server to perform the method according to claim 11.

23. A computer-readable medium, with a computer program according to claim 22 stored thereon.
